(19) United States
(12) Patent Application Publication
(10) Pub. No.: US 2002/0132583 A1
(43) Pub. Date: Sep. 19, 2002

(54) Antenna system, software and methods for locating an object

(76) Inventor: Lenka M. Jelinek, Hillsboro, OR (US)

Correspondence Address: MARGER JOHNSON & McCOLLOM, P.C., 1030 S.W. Morrison Street, Portland, OR, 97205, US

(21) Appl. No.: 09/812,474

(22) Filed: Mar. 19, 2001

(51) Int. Cl. H04B 5/00

(52) U.S. Cl. 455/41

(57) ABSTRACT

A system of antennas, software, and methods are provided for locating and identifying objects that include RF transponders. A single antenna driver feeds a signal to a multiplexer, which activates sequentially the antennas of the system. A return signal is matched with the known signatures of an object. The object is matched with the known location of the antenna that provided the return signal.

### BACKGROUND

The present invention is related to the field of antennas for determining a position of an object that includes a suitable transponder, and software and methods of locating and identifying such objects.

### BRIEF DESCRIPTION OF THE DRAWINGS

FIG. 1 is a diagram of a toy set made according to an embodiment of the invention.

FIG. 2 is a diagram of an electrical circuit made also by components of a set according to an embodiment of the invention.

FIG. 3 is a timing diagram of electrical signals to and from individual antennas of FIG. 2, according to an embodiment of the invention.

FIG. 4 is a flowchart illustrating a method according to an embodiment of the invention.

### DETAILED DESCRIPTION

The present invention provides a system of antennas, software, and methods for locating and identifying an object that includes an RF transponder. Some embodiments of the invention are suited for toys that are placed on a play device, although the invention is not limited in this respect.

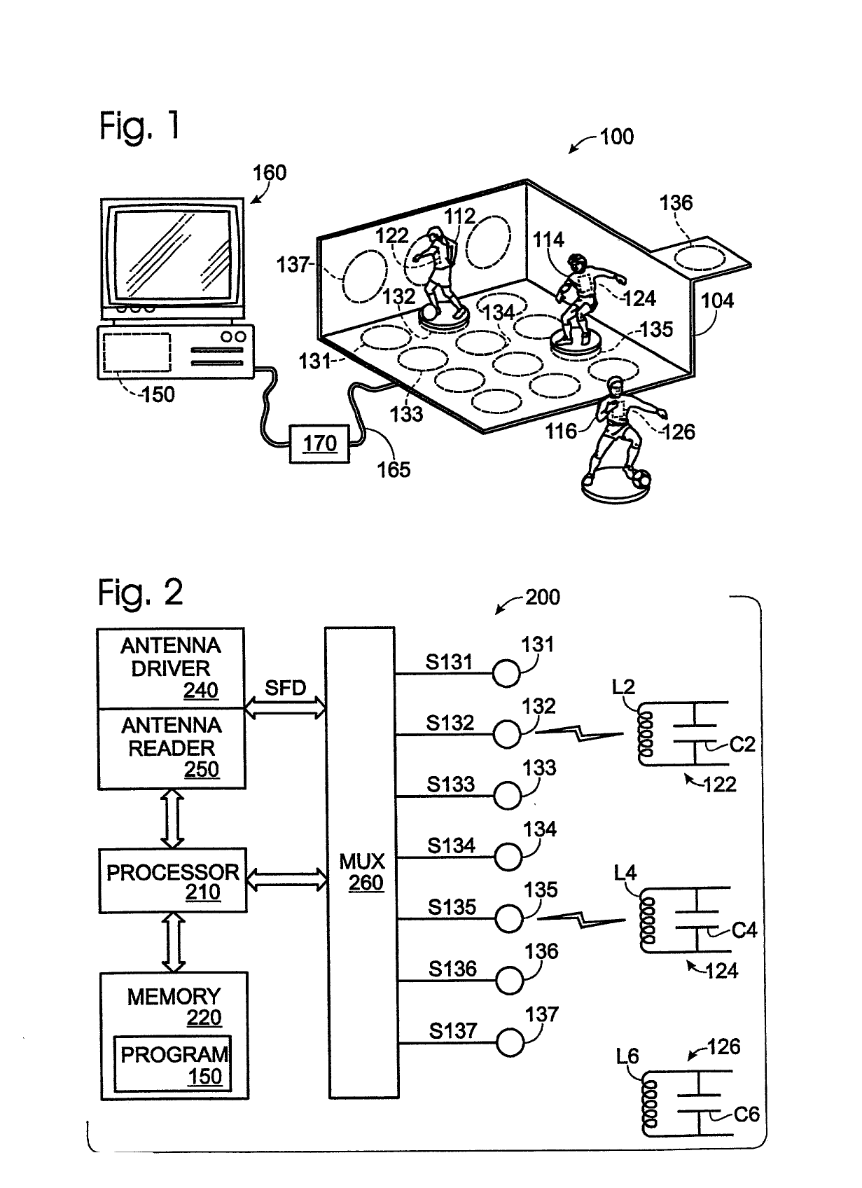

Referring now to FIG. 1, a set 100 according to an embodiment of the invention is described. Set 100 optionally includes a play device 104. Play device 104 may be a simulation of a building e.g., a house, a castle, a gasoline station, or a game arena, or a board for a board game, etc.

Set 100 also includes toy figurines 112, 114, and 116. Of these, toy figurines 112 and 114 are placed on play device 104. Toy figurine 116 is shown off the play device 104.

Toy figurines 112, 114, and 116 are those of humans in various poses, although the invention is not limited in that respect. The toy figurines may be those of animals, imaginary characters, game pieces, and of inanimate objects, such as automobiles, furniture, etc.

Toy figurines 112, 114, and 116, respectively, include radio frequency (RF) transponders 122, 124, and 126. RF transponders 122, 124, and 126 may be embedded in the figurines, so as not to be accessible to a child playing with them. If the figurines are provided with bases, then RF transponders 122, 124, 126 may be embedded in the bases, which work well for a coil-type RF transponder. If the RF transponders 122, 124, and 126 are in bases, the bases may be detachably connected to the figurines such that a single base with its corresponding transponder can be detached from one figurine and attached to another. Placing the RF transponders in the bases is also advantageous for optimum coupling where the play device 104 is a flat surface. The bases may have different shapes e.g., sleeves and be connected to the figurines at different positions e.g., at the bottom of the figurines.

In one embodiment, each of RF transponders 122, 124, and 126 has a unique response characteristic (not shown separately from the RF transponders 122, 124, and 126). That is, each of RF transponders 122, 124, and 126 may return a unique signal. In other embodiments, RF transponders 122, 124, 126 of groups of similar figurines (such as all animals, all white pawns of a chess set, all members of the same team, and the like) may have a similar return signal. In one embodiment, toy figurines 112, 114, and 116 may include means e.g., a button (not shown) or a retractable sleeve (not shown), for changing the return signal such that a player assigns each of the toy figurines 112, 114, and 116 to a particular group or assigns each of the toy figurines 112, 114, and 116 a particular identity. For example, a player may chose to assign figurine 112 as a soccer goal tender for a first soccer team by moving a switch (not shown) on the figurine 112 to a first position while assigning figurines 114 and 116 as members of a second soccer team by moving switches (not shown) on each of figurines 114 and 116 to a second position.

Alternatively, a player may chose to assign figurine 112 as a dog and figurine 114 as a child by moving a sleeve (not shown) into an appropriate position. The sleeve (not shown) may be part of the base of the figurine. The RF transponder 122, 124, and 126 return signals may be based on frequency, although the invention is not limited in this respect.

A set made according to the invention also includes at least two antennas e.g., antennas 131, 132, 133, 134, 135, 136, 137 and others (shown in dashed lines on FIG. 1). Antennas 131-137 may be located at various places on play device 104. In one embodiment, the antennas 131-137 are located on play device 104 substantially where the toy figurines are expected to be placed. The location expectation may be determined either from instructions to or features painted on play device 104.

In the embodiment of FIG. 1, antennas 131-137 are shown embedded in walls of the play device 104, although the invention is not limited in that respect. Indeed, antennas 131-137 according to the invention may be provided separately, for placing on various locations of any play device. In such embodiments, set 100 need not include the play device 104.

Antennas 131-137 may be coil antennas, although the invention is not limited in that respect. The advantage of coil antennas is that they may be embedded within a thin surface of play device 104. Alternately, they may be overlaid to the play device 104.

For orientation purposes, the antennas may have a main axis that is associated with a direction of the strongest detection. If they are coil antennas, the axis may be perpendicular to a main plane of the coil. The antennas may be oriented such that their main axes are substantially parallel to each other. This happens when they are arranged on a flat surface, such as, for example, antennas 131-135. Antenna 136 has its main axis parallel to those of antennas 131-135, but not in the same plane (it is elevated). Alternately, the antennas 131-137 may be oriented such that their main axes are not parallel to each other. One example is antenna 137, which includes a main axis that is oriented perpendicularly to antennas 131-136.

Set 100 also includes software 150. Software 150 may be adapted to determine where the toy figurines 112, 114, and 116 are located with respect to antennas 131-137. Software 150 may also be adapted to determine the identity of toy figurines 112, 114, and 116. In the embodiment of FIG. 1, since antennas 131-137 are at fixed locations with respect to play device 104, the software 150 also determines where the figurines 112, 114, 116 are with respect to play device 104. Software 150 determines location and identity of toy figurines 112, 114, and 116 from the return signals of RF transponders 122, 124, and 126, respectively.

In one embodiment, software 150 is provided in a storage medium, such as a diskette, along with set 100. In another embodiment, software 150 is provided separately. For example, it may be available for downloading through a global computer network such as the Internet®.

In one embodiment, the invention may be used with a personal computer 160. Cables 165 from each of antennas 131-137 may be coupled with personal computer system 160. In another embodiment, the invention may be used with a custom controller 170. Controller 170 may be coupled to play device 104 through cables 165.

In yet another embodiment, the invention may be used with both a personal computer 160 and a custom controller 170 as shown in FIG. 1. The controller 170 may include electronics not traditionally found in a personal computer 160 and specially attuned to the needs of antennas 131-137. The software 150 may be stored within personal computer system 160, within controller 170, or both.

Referring now to FIG. 2, an electrical circuit 200 according to an embodiment of the invention is described in more detail. It will be appreciated that portions of electrical circuit 200 may be included in a set according to an embodiment of the invention, while others are simply provided without necessarily belonging in a set according to the embodiment of the invention.

Circuit 200 includes a processor 210 and a memory 220. Processor 210 may be either a processor in personal computer 160, controller 170, or both. Memory 220 may be either a memory in personal computer 160 or controller 170 or both. Software 150 may reside on memory 220.

Circuit 200 also includes an antenna driver 240 and antenna reader 250. Antenna driver 240 and antenna reader 250 are typically provided in a single unit, although the invention is not limited in that regard. Processor 210 controls antenna driver 240, and receives inputs from antenna reader 250.

Circuit 200 also includes a multiplexer 260. Processor 210 preferably controls multiplexer 260, although the invention is not limited in that regard. Multiplexer 260 is connected with each one of the antennas 131-137. In another embodiment, multiplexer 260 may be two or more distinct multiplexers with each multiplexer being connected to a subset of antennas. For example, a first multiplexer (not shown) may be connected to antennas 131-134 and a second multiplexer (not shown) may be connected to antennas 135-137.

Antennas 131-137 have physical locations as shown in FIG. 1 with respect to play device 104, and together they form a system of antennas. The physical locations are known to software 150 as are their spatial relationships relative to play device 104.

The RF transponders 122, 124, and 126 are shown by their equivalent electrical circuits. RF transponder 122 includes an inductor L2 connected in parallel to a capacitor C2. RF transponder 124 includes an inductor L4 connected in parallel to a capacitor C4. RF transponder 126 includes an inductor L6 connected in parallel to a capacitor C6. In each transponder circuit, the inductor is shown connected in parallel with its corresponding capacitor, although the invention is not limited in that regard. In each case, the combination of the inductor and capacitor, and possibly also other components may contribute to form a unique identifying signature of the RF transponder. Alternatively, all RF transponders issue identical return signals that are differentiated by a processor 210 (FIG. 2) or software 150 as further explained below.

It will be observed that RF transponder 122 is shown coupled with antenna 132 and RF transponder 124 is shown coupled with antenna 135, consistently with FIG. 1. RF transponder 126 is not coupled with any antennas.

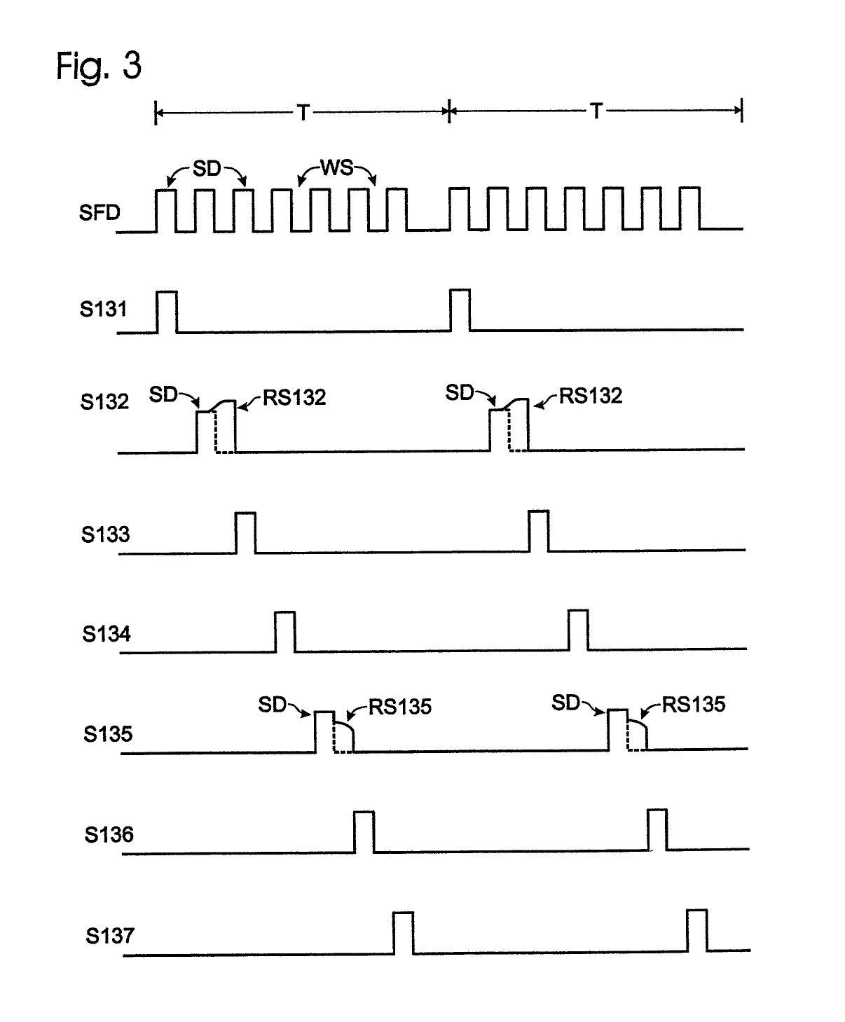

Referring now to FIG. 3, antenna driver 240 outputs a full antenna driving signal SFD to multiplexer 260. In the embodiment of FIG. 3, signal SFD includes driving signals SD, which are separated by waiting spaces WS. In the embodiment of FIG. 3, driving signals SD and waiting spaces are equal duration pulses. The present invention is, however, not limited in that regard. The driving signals SD may be shorter pulses e.g., spikes, while the waiting spaces WS may be relatively longer.

Multiplexer 260 distributes the full antenna driving signal SFD to the antennas 131-137. Each antenna receives a driving signal SD, followed by a corresponding waiting space WS. The driving signal SD activates every antenna it reaches.

When any one of antennas 131-137 is activated by a driving signal, it emits a detection signal (not shown). The detection signal is an electromagnetic signal in space. When an RF transponder is nearby, it emits a return signal S131-S137, which, in turn, is received by an antenna. During the waiting space WS, the return signal is processed by the multiplexer 260 and output to antenna reader 250. For example, a driving signal SFD activates antennas 132, 135, and 136 that, in turn, each emit a detection signal (not shown). RF transponders 122 and 124 emit a return signal to antennas 132 and 135, respectively. The return signals RS132 and RS135 from RF transponders 122 and 124 are processed by multiplexer 260 and provided to antenna reader 250 during the waiting space WS.

In FIG. 3, the full antenna driving signal SFD and the driving signals S131-S137 for each of the antennas 131-137 are plotted together. It will be observed that signals S131, S133, S134, S136 and S137 have no return signal during the waiting space WS. On the other hand, signals S132, and S135, respectively, have return signals RS132 and RS135 during their waiting spaces WS. Processor 210 interprets the return signals RS132 and RS135.

In one embodiment, return signals RS132 and RS135 are distinct from each other because they are generated by different RF transponders 122 and 124, respectively. In another embodiment, return signals RS132 and RS135 are identical. In yet another embodiment, the processor 210, with the help of software 150, may associate a given return signal with a corresponding antenna and an originating transponder, and thus determine the identity and location of each toy figurine on the play device 104. The information is used for subsequent play. In yet another embodiment, multiplexer 260 determines the proximity of one toy figurine to another by measuring the strength of the return signals RS 132 or RS 135. If, for example, toy figurines 112 and 114 are in close proximity to a single antenna e.g., antenna 135, the return signal RS135 is larger.

Optionally, the full antenna driving signal SFD has one pulse for each of antennas 131-137. After antenna 137 has also been activated, the full antenna driving signal SFD may optionally be redirected to start again from antenna 131. An example sampling rate would be 2 kHz or 2000 samples per second for each antenna. This means that a period T for activating each of antennas 131-137 once would be 0.5 msec.

It should be readily apparent that one or more devices that include logic circuit may implement the present invention. A dedicated processor system that includes a microcontroller or a microprocessor may alternatively implement the present invention.

The invention additionally provides methods, which are described below. Moreover, the invention provides apparatus that performs or assists in performing the methods of the invention. This apparatus may be specially constructed for the required purposes or it may comprise a general-purpose computer selectively activated or reconfigured by a computer program stored in the computer. The methods and algorithms presented herein are not necessarily inherently related to any particular computer or other apparatus. In particular, various general-purpose machines may be used with programs in accordance with the teachings herein or it may prove more convenient to construct more specialized apparatus to perform the required method steps. The required structure for a variety of these machines will appear from this description.

Useful machines or articles for performing the operations of the present invention include general-purpose digital computers or other similar devices. In all cases, there should be borne in mind the distinction between the method of operating a computer and the method of computation itself. The present invention relates also to method steps for operating a computer and for processing electrical or other physical signals to generate other desired physical signals.

The invention additionally provides a program and a method of operation of the program. The program is most advantageously implemented as a program for a computing machine, such as a general purpose computer, a special purpose computer, a microprocessor, and the like.

The invention also provides a storage medium that has the program of the invention stored thereon. The storage medium is a computer-readable medium, such as a memory, and is read by the computing machine mentioned above.

A program is generally defined as a sequence of steps leading to a desired result. These steps, also known as instructions, are those requiring physical manipulations of physical quantities. Usually, though not necessarily, these quantities take the form of electrical or magnetic signals capable of being stored, transferred, combined, compared, and otherwise manipulated or processed. When stored, they may be stored in any computer-readable medium. It is convenient at times, principally for reasons of common usage, to refer to these signals as bits, data bits, samples, values, elements, symbols, characters, images, terms, numbers, or the like. It should be borne in mind, however, that all of these and similar terms are associated with the appropriate physical quantities, and that these terms are merely convenient labels applied to these physical quantities.

This detailed description is presented largely in terms of flowcharts, display images, algorithms, and symbolic representations of operations of data bits within a computer readable medium, such as a memory. Such descriptions and representations are the type of convenient labels used by those skilled in programming and/or the data processing arts to effectively convey the substance of their work to others skilled in the art. A person skilled in the art of programming may use this description to readily generate specific instructions for implementing a program according to the present invention. For the sake of economy, however, flowcharts used to describe methods of the invention are not repeated in this document for describing software according to the invention.

Often, for the sake of convenience only, it is preferred to implement and describe a program as various interconnected distinct software modules or features, collectively also known as software. This is not necessary, however, and there may be cases where modules are equivalently aggregated into a single program with unclear boundaries. In any event, the software modules or features of the present invention may be implemented by themselves, or in combination with others. Even though it is said that the program may be stored in a computer-readable readable medium, it should be clear to a person skilled in the art that it need not be a single memory, or even a single machine. Various portions, modules or features of it may reside in separate memories or separate machines where the memories or machines reside in the same or different geographic location. Where the memories or machines are in different geographic locations, they may be connected directly or through a network such as a local access network (LAN) or a global computer network like the Internet®.

In the present case, methods of the invention are implemented by machine operations. In other words, embodiments of the program of the invention are made such that they perform methods of the invention that are described in this document. These may be optionally performed in conjunction with one or more human operators performing some, but not all of them. As per the above, the users need not be collocated with each other, but each only with a machine that houses a portion of the program. Alternately, some of these machines may operate automatically, without users and/or independently from each other.

Methods of the invention are now described. A person having ordinary skill in the art should recognize that the boxes described below may be implemented in different combinations, and in different order. Some methods may be used for determining a location of an object, some to determine an identity of an object, and some both.

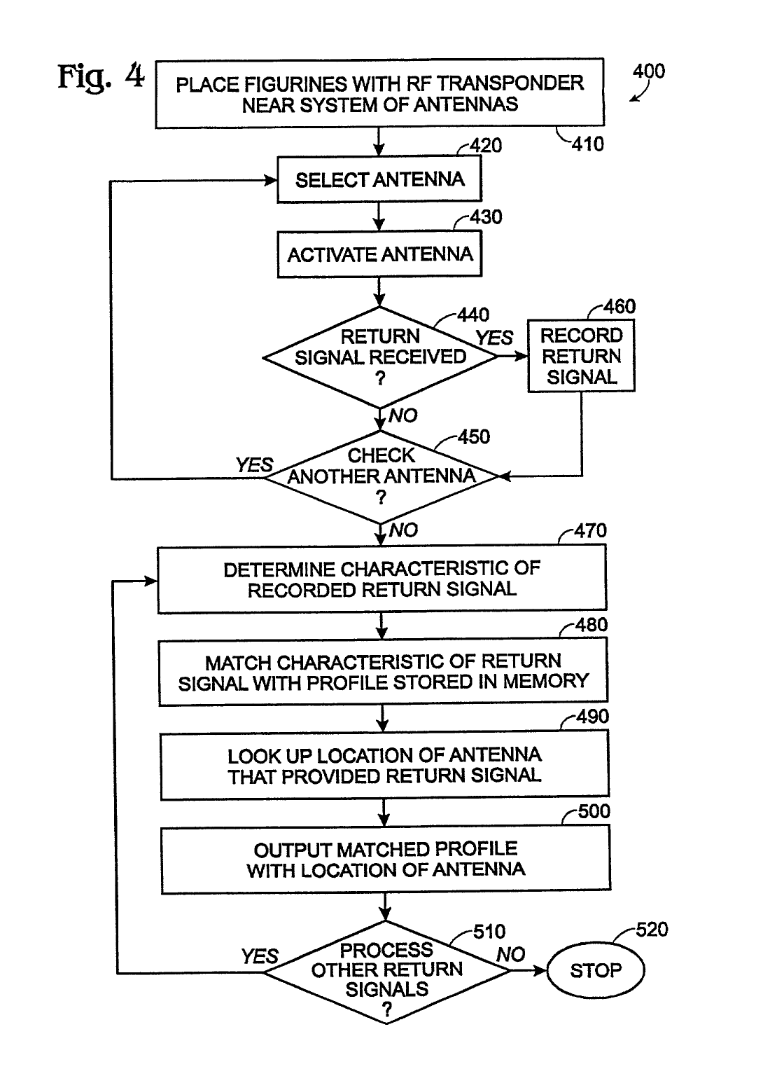

Referring now to FIG. 4, a flowchart 400 is used to describe a general method according to an embodiment of the invention.

According to box 410, one or more figurines, each with an RF transponder, are placed near a system of antennas. In one embodiment, the antennas are polled continuously regardless of whether there are figurines in their vicinity. The figurines may be moved during play. The system of antennas may be embedded in a play device as shown in FIG. 1.

According to boxes 420 and 430, an antenna in the system is selected (box 420) and activated (box 430). The antenna may be activated by sending an antenna driving signal from the circuit 200 (FIG. 2).

According to a box 440, it is determined if a return signal is received from the activated antenna. If so, the return signal is recorded at box 460. If a return signal is not returned from an activated antenna, it is determined if other antennas exist in the system (box 450). If so, execution returns to box 420. Antennas may be checked either sequentially or with an order adapted dynamically according to results, favoring antennas that provide return signals. Once all antennas are checked, execution returns to box 470.

In another embodiment, a routine may be executed to include repeating sequentially boxes 420, 430, 440, 450, and 460. In yet another embodiment, if a return signal is received in box 440, execution may jump directly from box 460 to box 470 and then from box 510 back to box 420.

According to box 470, a characteristic is determined of the recorded return signal. Briefly returning to FIG. 3, it will be observed that return signal RS 132 has a different shape than return signal RS135. The characteristic of the return signal that is determined may be either a maximum amplitude, a total amount of charge, or the like. More accurate results may be had by allowing a relatively large waiting space WS.

Referring back to FIG. 4, according to a next box 480, the determined characteristic of the returned signal is matched with a profile stored in a memory. This determines which RF transponder, and therefore which toy figurine, has generated the return signal.

According to a box 490, the identity and consequent location of the antenna that provided the return signal is determined. The location of the antenna that provided the return signal is known to the circuit 200 (FIG. 2) or the software 150 (FIG. 1) because a specific antenna e.g., antenna 135, is connected to a specific port on the multiplexer 260 (FIG. 2) e.g., PORT 5.

According to box 500, the matched profile of the toy figurine is outputted along with the location of the antenna. Further processing may take place then.

According to box 510, it is determined if other return signals remain to be processed. If so, execution loops back to box 470. If all recorded return signals have been processed, execution ends at box 520.

The invention has many advantages including the following. By activating each antenna separately from the others, the detection signal of any one of them is not misinterpreted as a return signal from an RF transponder. This permits placing antennas 131-137 closer to each other, and thus covering the area of the play device 104 with higher resolution. This permits detecting the position of the toy figurines 112, 114 more exactly. In addition, since each one of antennas 131-137 has to cover less area, its detection signal may be weaker. This permits making each of antennas 131-137 a coil antenna, of as little as a single turn.

Even though detection is performed for many areas, a single antenna driver 240 and a single antenna reader 250 are needed for a whole system of antennas 131-137. This reduces the overall cost of sets made according to the invention.

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While the invention has been disclosed in its preferred form, the specific embodiments thereof as disclosed and illustrated herein are not to be considered in a limiting sense. Indeed, it should be readily apparent to those skilled in the art in view of the present description that the invention may be modified in numerous ways. The inventor regards the subject matter of the invention to include all combinations and subcombinations of the various elements, features, functions and/or properties disclosed herein.

The following claims define certain combinations and subcombinations, which are regarded as novel and non-obvious. Additional claims for other combinations and subcombinations of features, functions, elements and/or properties may be presented in this or a related document.

The invention claimed is:

1. A set comprising:
an RF transponder to use with a toy;
at least two antennas to emit detection signals to the RF transponder; and
a multiplexer coupled to the two antennas to activate a first one of the antennas at a different time interval than a second one of the antennas.

2. The set of claim 1, wherein
the multiplexer is to activate periodically the first and the second antennas.

3. The set of claim 1, wherein
the antennas are coil antennas.

4. The set of claim 3, wherein
the coil antennas have single turn coils.

5. The set of claim 1, wherein
each of the antennas has a main axis, and
the antennas are oriented such that their respective main axes are not parallel to each other.

6. The set of claim 1, wherein
each of the antennas has a main axis, and
the antennas are oriented such that their respective main axes are substantially parallel to each other.

7. The set of claim 1, wherein
each of the antennas has a main plane, and
the antennas are oriented such that their respective main planes are substantially parallel to each other, but they do not belong in the same plane.

8. The set of claim 1, further comprising:
a program adapted to determine which one of the two antennas receives a return signal from the RF transponder.

9. A set comprising:
a toy figurine including an RF transponder;
at least two antennas to emit respective first and second detection signals at different times from each other;
an antenna reader to receive a return signal from the RF transponder responsive to one of the first and second detection signals.

10. The set of claim 9, further comprising:
an antenna driver; and
a multiplexer to receive a single antenna drive signal from the antenna driver, and to direct the antenna drive signal alternatingly between the first antenna and the second antenna to cause them to emit the first and second detection signals.

11. The set of claim 9, further comprising:
a program adapted to determine an identity of the toy figurine.

12. The set of claim 9, further comprising:
a program adapted to determine a location of the toy figurine.

13. A set for use with a program comprising:
a play device;
at least two antennas to emit respective first and second detection signals at different time intervals, the antennas positioned at first and a second antenna locations of the play device respectively;
a first toy to place on the play device including a first RF transponder to generate a first return signal in response to the first detection signal; and
a second toy to place on the play device including a second RF transponder to generate a second return signal in response to the second detection signal;
wherein the program is adapted to identify the first return signal with the first toy and the second return signal with the second toy.

14. The set of claim 13, further comprising:
an antenna driver; and
a multiplexer to receive a single antenna drive signal from the antenna driver, and to direct the antenna drive signal alternatingly between the first antenna and the second antenna to cause them to emit the first and second detection signals.

15. The set of claim 13, wherein
the program is adapted to determine first and second locations relative to the play device for the first and the second toys from the first and second return signals, respectively.

16. The set of claim 13, wherein
the first RF transponder has a first response characteristic,
the second RF transponder has a second response characteristic different from the first response characteristic, and
the program is further adapted to determine which of the first and second toys is at the first location.

17. The set of claim 9, wherein
the RF transponder is detachably connected to the toy figurine.

18. An article comprising: a storage medium, said storage medium having stored thereon instructions, that, when executed by at least one device, result in:
emitting a first detection signal from a first antenna;
emitting a second detection signal from a second antenna at a different time interval than emitting the first detection signal;
receiving a return signal from an RF transponder in response to one of the first and second detection signals; and
determining which one of the first and second antennas received the return signal.

19. The article of claim 18, wherein the instructions further result in:
determining a response characteristic of the return signal; and
matching the determined response characteristic with a response characteristic stored in a memory.

20. The article of claim 18, wherein the instructions further result in:
determining which antenna provided the return signal.

21. The article of claim 20, wherein the instructions further result in:
looking up a location of the antenna that provided the return signal.

22. A method comprising:
emitting a first detection signal from a first antenna;
emitting a second detection signal from a second antenna at a different time interval than emitting the first detection signal; and
receiving a return signal from an RF transponder in response to one of the first and second detection signals.

23. The method of claim 22, further comprising:
receiving a single antenna drive signal; and
multiplexing the antenna drive signal between the first antenna and the second antenna.

24. The method of claim 22, further comprising:
determining a location of the RF transponder from the return signal.

25. The method of claim 22, further comprising:
determining a response characteristic of the return signal; and
matching the determined response characteristic with a response characteristic stored in a memory.

26. The method of claim 22, wherein
multiplexing the antenna drive signal is performed periodically.
